(19) United States
(12) Patent Application Publication
(10) Pub. No.: US 2006/0168107 A1
(43) Pub. Date: Jul. 27, 2006

(54) Generalized on-demand service architecture for interactive applications

(76) Inventors: Rajesh K. Balan, Pittsburgh, PA (US); Paul C. Castro, White Plains, NY (US); Maria R. Ebling, White Plains, NY (US); Archan Misra, Irvington, NY (US)

Correspondence Address: THE LAW OFFICE OF IDO TUCHMAN, 69-60 108ST., SUITE 503, FOREST HILLS, NY, 11375, US

(21) Appl. No.: 10/801,896

(22) Filed: Mar. 16, 2004

(51) Int. Cl. G06F 15/16

(52) U.S. Cl. 709/218

(57) ABSTRACT

A method, system, and computer program for executing a network-based distributed application. An infrastructure is described that includes application containers configured to execute an application instance of the distributed application and measure quality of service metrics for the application instance. Workload management elements form a decentralized workload management layer. The workload management layer is configured to assign a workload to application containers based on the quality of service metrics received by the application containers.

### CROSS-REFERENCE TO RELATED APPLICATIONS

This patent application is related to co-pending U.S. patent application Ser. No. 10/718,401 titled “Adaptive Load Distribution in Managing Dynamic and Transient Data for Distributed Applications” filed Nov. 19, 2003, which is commonly owned and is hereby incorporated by reference in its entirety.

### FIELD OF THE INVENTION

The present invention relates to distributed computing, and more specifically, to middleware for network-based distributed applications.

### BACKGROUND

With the increasing popularity of the Internet, distributed computing has become very popular. Distributed computing refers to a computer configuration where a group of computing devices (referred to as servers) collectively provides one or more computing-related services (referred to as applications) to computers using the services (referred to as clients). Distributed computing allows computational burden (referred to as workload) to be shared across multiple servers and helps reduce catastrophic single-point failures. Accordingly, many indispensable Internet-based services, such as the Domain Name Service (DNS) used to resolve machine host names to IP addresses and popular search engines, are implemented as distributed services, with multiple servers collaboratively supporting a large set of clients.

Any distributed system must provide a mechanism of workload distribution, since the servers must use some protocol to negotiate or decide the way in which the total workload is allocated among the constituent servers. The total workload itself can be considered to be defined by an abstract workload space. Among other things, this space can consist of application-specific objects, such as files or other data elements. The overall workspace is typically managed in a cooperative distributed environment by either partitioning or replication.

Partitioning involves assigning each server responsibility for some portion of the overall workload space. In such a strategy, the overall workspace of the application, such as the files stored by a distributed file system, is partitioned among the different servers, with each individual component of the workspace element being allocated to a specific server. Clients interested in retrieving or modifying a particular component must then be routed to the server that is responsible for the corresponding portion of the workspace.

In a replication arrangement, the entire workspace (the entire contents of the application) is copied to each of the constituent servers so that each server can essentially operate stand-alone. Using this approach, the contents of all the servers are identical and a copy of each individual component is present at each server. A client interested in retrieving or modifying a state element can thus interact with any individual server. Each server is responsible for keeping all other servers informed of any changes to the state of any component.

Whether the distributed environment is implemented using a distributed or replication methodology, the client-server model splits application functions between one or more servers. The server is typically a powerful computer as compared to the client, hosting common functions that are shared by many applications. Unlike the mainframe model, in which all application functions reside on the server, clients in the client-server model run non-trivial application code. As an example, automated teller machines (ATMs) are clients that run application code implementing basic banking tasks such as withdrawals and deposits into personal bank accounts, while server machines are responsible for exchanging data with ATM machines and actually committing the banking transactions requested by the ATM machines.

The Internet has brought universal connectivity to general-purpose computers, providing a medium to develop and deploy large-scale applications that can reach millions of clients. For example, many business applications are well suited to allow connectivity to data by potentially millions of clients. Such business applications tend to have static infrastructure and client interaction, with relatively predictable workload. In general, clients using business applications tend to read data from servers far more frequently than writing data. For applications where the shared data is relatively static, scalability can be achieved through replication and caching mechanisms that employ centralized control mechanisms.

While conventional client-server models are successful at supporting many business applications, there is an emerging class of network-based, highly interactive applications that operate outside the usual assumptions made in conventional client-server models. These applications can be characterized by their requirement of informing clients of changes to highly dynamic state in close to real-time. In such applications, the state often changes rapidly due to rapid updates (writes) by the client devices or applications. Such applications include, but are not limited to, multi-player online games, directory services for pervasive data sources and distributed storage of vehicular information (Telematics).

For example, there is an increasing market for massively multiplayer on-line games (MMOG) played over virtual worlds. In these applications, potentially hundreds of thousands (or millions) of clients interact in a virtual space maintained on a set of servers. As clients interact in the virtual space, the effects of their actions must be distributed to other clients. Clients are far more interactive with servers and write and read data at equal frequencies, precluding standard replication and caching strategies for scaling as well as centralized management schemes. The workload presented to servers from clients is difficult to predict and may change quickly over time.

For such applications, replication is generally not a feasible strategy since the overhead of maintaining identical copies of rapidly changing components at multiple servers proves to be unacceptable. Accordingly, such distributed applications employ partitioning to spread out the processing load. Most of the current implementations of such workload spreading, however, have two basic limitations.

First, the number of servers over which the application is distributed is decided a-priori. Normally, some off-line technique, such as predictions of the forecast client loads, is used to calculate the number of servers needed. Once a set of servers are dedicated to a particular application, they typically remain committed to that application, even though the workload levels may unexpectedly increase or decrease from their predicted profile.

Second, the partitioning of the responsibility among the set of constituent servers is also decided a-priori. From an abstract point of view, this partitioning is usually based on dividing up of some namespace. For example, a set of 26 servers can carve up responsibility for storing files by assigning each server responsibility for a unique letter of the alphabet (e.g., Server 1 manages all files having names beginning with “A”, Server 2 all files having names beginning with “B”, etc.), or different servers can be assigned to handle different Internet domains (e.g., Server 1 handles .com, while Server 2 handles .org, etc.).

One drawback of conventional distributed computing applications is that they typically lack on-demand allocation of resources. Often times, the running cost of an application is based on the quantity of computing resources (e.g., the number of servers) that it consumes if this number is fixed and decided a-priori, then it is generally based on a peak load (worst case) estimate. Such peak-based provisioning is often wasteful since the application incurs expense even when the loads are potentially much lower and can be serviced by a much smaller set of servers.

Another related drawback of current distributed application schemes is the lack of adaptation in workload partitioning. To effectively utilize a given set of servers, the application should be capable of dynamically modifying the partitions (portions of the total workspace) assigned to individual servers. The basic idea of adaptive partitions is to allow a server facing unexpectedly high workloads (or some other problems) to seamlessly migrate some of its responsibility to one or more alternative servers, which currently may have spare capacity. With this form of adaptive partitioning, the distributed system can adjust the allocation of responsibility in response to changing skews in the actual workload.

Furthermore, client-server models generally do not explicitly provide a means for applications to share infrastructure that solves common problems, particularly those due to scaling an application to support many clients. Without a shared infrastructure, many application developers build their own custom infrastructure that inhibits intra-application interactions and increases development time.

Some modern network-based applications rely on a tiered model of computing. In this model, application servers, executing middleware software, provide a platform for deploying generic applications. The middleware is responsible for performance, distribution, fault-tolerance and reliability, and other quality-of-service (QoS) issues. Developers write their applications to conform to a logical component model defined by the middleware. The logical component model is implemented by middleware, called component transaction monitors, which handle system level details of executing the applications. In this manner, application developers can focus more on logic specific to the tasks an application is supposed to implement and worry less about achieving an acceptable QoS level when their application runs.

Different standards exist that specify how different components in the tiered model are supposed to interact. For example, the J2EE framework (see Java 2 Platform, Enterprise Edition, http://java.sun.com/j2ee) specifies how business process-oriented applications should be written and what interfaces an application server must provide. This framework has been used successfully for deploying many business applications that can be accessed by client devices over the World Wide Web (WWW). However, there currently exists little infrastructure support for developing and deploying highly dynamic distributed applications.

As mentioned above, the Internet has brought universal connectivity to general-purpose computers. With many homes connected to the Internet over moderately priced high-bandwidth connections, there is an increasing market for selling real-time, highly interactive games that support thousands of players, often referred to as massively multiplayer on-line games (MMOGs). The premise of many of these games usually revolves around a virtual environment with a player taking the role of a virtual character (known as an avatar). A player's avatar has the ability to explore and interact with virtual objects and characters in the game world. More importantly, the avatar can interact with other avatars of players currently playing the game.

These games provide entertainment for players who typically pay a monthly subscription fee to gain access to the virtual world. Unlike traditional computer games that run on a single desktop machine, the games are usually played across the world, twenty four hours a day, seven days a week. Even if a player leaves the virtual world, the game continues and the player must return frequently to keep up with the changes made in the virtual world during his or her absence.

Because of the “always-on” nature of the game and the fact that it is played by paying subscribers across the world at all times of day, there is a high expectation that the game is always available to be played, and that the user experience closely match the user experience of more traditional, single-player games. Many players have an extremely low tolerance for failure in the game and lag, or the latency the player experiences when interacting with the virtual world, must be low (on the order of 100 milliseconds or less is usually acceptable). To make matters more complex, game designers often want to create larger, more detailed game worlds and scale the number of concurrent players in that world to millions.

There typically exists no generalized infrastructure to support the needs of MMOGs and other highly interactive applications. As mentioned, current tiered architectures such as J2EE are geared towards business applications, which have very different workload characteristics and employ other solutions to scale to large numbers of clients. MMOGs are usually deployed on computer architectures that are custom built for the specific game. Each game requires its own architecture with little explicit facilities that promote sharing of resources between games from a common infrastructure.

To scale a single game to many players, MMOG designers typically rely on running multiple instances of a game, with each game executing on its own independent architecture. Players choose the game instance they would like to play and log into that server. This lowers the lag perceived by the players, but constrains the number of players who can concurrently play the same game. Specifically, players only interact with other players logged into the same server. While a game may have millions of subscribers, the actual number of players that can concurrently play a game is far less than that.

FIG. 1 shows an example of a conventional tiered architecture 102 that can be used to support a MMOG (or any other highly interactive application). Clients 104 are connected to a wide-area network 106, such as the Internet, in order to access the MMOG. The MMOG logic is actually executed on one or more application servers 108, which are specifically configured for that particular game. Each application server 108 runs exactly the same code such that, from the client's perspective, it is unimportant which application server 108 actually services its request.

All client requests are initially received by a load balancer 110, which is responsible for distributing requests to the application servers 108. The normal decision process at the load balancer 110 is to forward the client request to the application server 108 that is the least busy. This way, no single application server 108 is overloaded. Usually, all application servers 108 can communicate with one or more backend servers 112 such as a database server, to access shared functionality. In the example of an MMOG, the backend servers 112 maintain the current state of a virtual world (e.g. positions of objects and players, status of players, etc) while the application servers 108 execute game logic.

The load balancer 110, application servers 108, and backend servers 112 can collectively be known as the game server 114. While adding more application servers 108 can scale game servers 114 to a large number of clients 104, at some point the load balancer 110 and backend servers 112 can become bottlenecks. To scale a game server 114 to support more clients, MMOG developers simply create a replica of the game on a different, independently operating game server 114. FIG. 2 illustrates how this is done.

In FIG. 2, clients 104 can choose between two different, independently executing instances of the application runing on different game servers 114. For example, clients 202 may choose to interact with the game server 114 executing application instance 1 204, while clients 206 may choose to interact with the game server 114 running application instance 2 208. Since neither game server 114 communicates with the other, all interactions between clients 202 and application instance 204 are unknown to clients 206 and application instance 208. The effect of this in an MMOG application is that clients 202 and clients 206 are effectively playing two different games.

Clients 104 are often aware of the multiple game servers 114 and manually choose which game server 114 to communicate with (normally specified by a hostname/network address of the entry point into the server architecture). If the client 104 is not explicitly aware of the game servers 114, some part of the application code is used to artificially partition clients 104 to game servers 114 using some attribute of the client 104 (for example, the geographic location of the client). Once the client 104 selects (or is assigned) a particular game server 114 it remains locked to this server in order to play the game. If the client 104 switches to a new game server 114, it is essentially playing a different instance of the same game since the state of the game is different on each game server 114.

Replication and static client/server assignments limits the overall scalability of the architecture. The architecture does not make efficient use of the total capacity of all game servers 114 on the network 106. For instance, a game server 114 that is heavily loaded cannot migrate clients 104 to a game server 114 that is lightly loaded without forcing the clients 104 to a new instance of the game.

### SUMMARY OF THE INVENTION

The present invention overcomes the drawbacks of conventional distributed applications mentioned above by providing an infrastructure to better support network-based, highly interactive applications. Application code is written to conform to an interface provided by an application container. The application container is responsible for executing arbitrary application code and providing an interface to a middleware infrastructure that provides quality of service (QoS) functions common to applications. Application code is deployed into the application container for execution. Application code is primarily responsible for responding to client requests, where such requests interact with some persistent state managed by the application and common to all clients (e.g. the state of a multiplayer game). During execution, clients use the application through a prescribed interface.

In one embodiment of the invention, application containers monitor metrics associated with QoS for each application it is executing. If the QoS falls below desired levels, the application container requests reassignment of work from the infrastructure. Upon reassignment of work, one or more application containers begin to execute application code and clients migrate to appropriate application containers. Moreover, although the application code itself runs on multiple application containers, the application code is itself unaware of the exact number of such containers being used, or of the pieces of the application code that are being managed on different containers. It is the job of each container to share appropriate state information about its portion of the application with other appropriate containers to ensure that the application logic remains consistent.

One feature of the present invention is that it allows the application container to maintain client-container consistency by simply requiring the application code to suitably tag every outgoing or incoming packet before forwarding it to the container. Once the packets are tagged, the containers run distributed logic among themselves to determine all the other containers that should receive each such tagged packet and forward it to their instance of the application.

Writing an application to conform to the application container's interface may further include a decision by the application code of the optimal way of expanding or contracting the portion of the application that is presently running in that particular container. This decision is dependent on the application logic and may further include a method to group logical work units into categories such that one category is distinct from another. In this manner, the application may receive a request (work unit) from a client and determine that this request should be handled by application code executing on another application server. Monitoring QoS levels may further require the aggregation of QoS levels from multiple applications executing on the same application container. In other words, application containers are shared resources for distinct applications and the QoS for one application is a function of the aggregate workload received from all clients in the system. Reassigning work for an application may further require the container to locate appropriate resources using a lookup mechanism that can determine what other application servers are available and have free capacity.

One exemplary aspect of the present invention is an infrastructure that provides workload management and consistency control mechanisms for application containers. The infrastructure is a de-centralized component that provides distributed networking, reliability, and consistency control for applications.

Another exemplary aspect of the present invention is a mechanism that separates application logic from QoS logic. Application containers implement a specified interface that connects to the workload management infrastructure. Thus, applications need minimal awareness of distribution during their development and are transparently executed on the present invention.

Yet another exemplary aspect of the present invention is a generic mechanism that allows individual applications the ability to specify how different types of operations/work performed by an application can be categorized into groups. Applications may also specify QoS measures that the workload management infrastructure uses when allocating and de-allocating application containers for an application.

The foregoing and other features, utilities and advantages of the invention will be apparent from the following more particular description of various embodiments of the invention as illustrated in the accompanying drawings.

### BRIEF DESCRIPTION OF THE DRAWINGS

FIG. 1 shows an example of a conventional tiered architecture that can be used to support interactive applications.

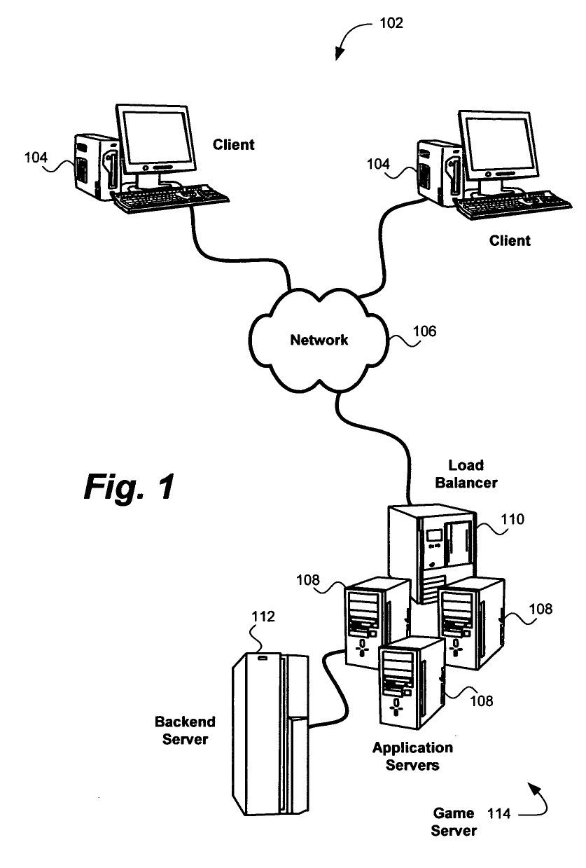

FIG. 2 shows an example of a conventional tiered architecture scaled to execute instances of an application running on different game servers.

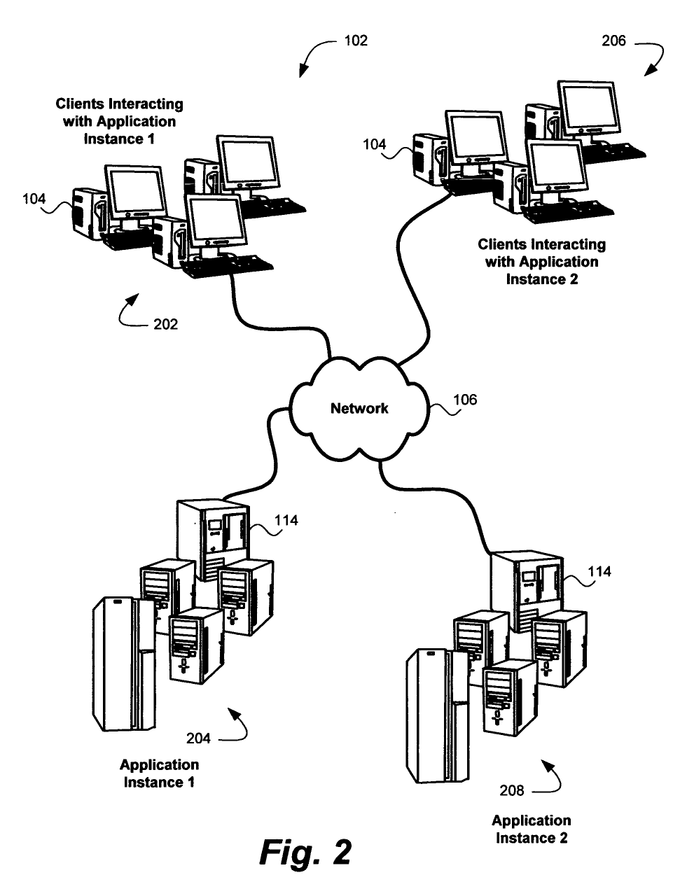

FIG. 3 shows an exemplary environment embodying the present invention.

FIG. 4 shows a diagram of exemplary functional architecture for executing highly interactive applications according to an embodiment of the present invention.

FIG. 5 shows an exemplary system deploying highly interactive applications according to one embodiment of the present invention.

FIG. 6 shows an exemplary two-dimensional map of a virtual world divided into cells according to the present invention.

FIG. 7 shows an exemplary flowchart for generating application keys according to the present invention.

FIG. 8 shows an exemplary flowchart that an application container performs when loading and executing an application.

FIG. 9 shows an exemplary flowchart illustrating the operations an application container performs when receiving a client request.

FIG. 10 shows an exemplary flow chart illustrating the basic steps a workload management layer performs when a client request is received.

FIG. 11 shows an exemplary flowchart illustrating the steps taken by a workload management layer when it receives a load report from an application container.

FIG. 12 shows an exemplary flowchart illustrating how an application container reports its load to a workload management layer.

### DETAILED DESCRIPTION OF THE INVENTION

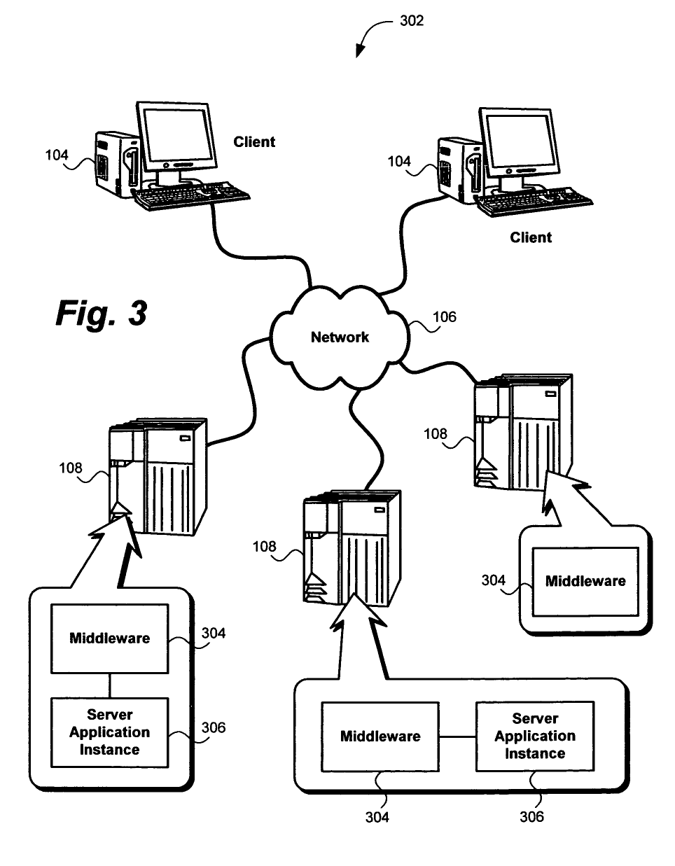

The following description illustrates how the present invention is employed to execute highly interactive applications and deploy resources in an adaptive, on-demand manner. FIG. 3 shows an exemplary environment 302 embodying the present invention. It is initially noted that the environment 302 is presented for illustration purposes only, and is representative of countless configurations in which the invention may be implemented. Thus, the present invention should not be construed as limited to the environment configurations shown and discussed herein.

The environment 302 includes a plurality of clients 104 and a plurality of servers 108 coupled to a network 106. The network 106 may be any network known in the art for effectuating communications between the various devices in the environment 302. Thus, the network 106 can be a local area network (LAN), a wide area network (WAN), or a combination thereof. It is contemplated that the network 106 may be configured as a public network, such as the Internet, and/or a private network, and may include various topologies and protocols known in the art.

The clients 104 and servers 108 may be various computing devices known to those skilled in the art. For example, clients 104 and servers 108 may be various general-purpose computers configured with a central processing unit (CPU), main memory and an input/output unit. The clients 104 and servers 108 may be further equipped with secondary memory, such as magnetic and optical disk drives, input hardware, such as a keyboard and mouse, and output hardware, such as a display adapter and monitor.

As shown, the servers 108 are configured to execute middleware 304 and one or more application instances 306. The application instances 306 may be of any application configured in accordance with the present invention. Typically, the application instances 306 are highly interactive applications, especially suited for execution using the present invention. Examples of such applications include massively multiplayer on-line games, and telematics services such as fleet management over large geographic areas. Furthermore, the middleware 304 and application instances 306 may be in embodied in various tangible media know in the art, including, but not limited to, read only memory, random access memory, data streams, optical and magnetic memory, and the like.

As described in detail below, application workload, such as stream-oriented data sent to and received by the servers 108 over the network 106, passes through the middleware 304 before entering or leaving the application instances 306. In a particular embodiment of the invention, the middleware 304 deploys additional servers 108 when workload and/or quality of service (QoS) metrics fall outside an acceptable range. For example, the workload assigned to an application instance 306 may be reduced when quality of service metrics reach an overload threshold value and increased when quality of service metrics reach an under-load threshold value. By making the deployment of additional servers 108 a function of workload and/or QoS metrics, the distributed application 306 can considerably reduce its need for the average number of computing devices. Thus, middleware 304 increases the number of servers 108 during spikes in the workload, and similarly reduces the number of participating servers 108 when the workload intensity diminishes. Under this approach, the capacity of the application 306 can be defined by the cumulative capacity of all the servers, and not be bottlenecked by the capacity of an individual server, since the application could now dynamically relocate load from an overloaded server to an under-loaded one.

As described below, an embodiment of the middleware 304 takes advantage of the tiered model of computing to support applications. The middleware 304 is more cognizant of the operating behavior of network-based interactive applications and supports some or all of the following characteristics:

Adaptive—highly interactive applications present a high volume, dynamically changing workload. The middleware 304 supports these applications efficiently and handles a wide range of workloads while ensuring enough resources are available to handle peak loads.

Generalized Architecture—many highly interactive applications require the same type of infrastructure support to deal with aspects of distributed networking, fault-tolerance and reliability, and consistency control. Infrastructure support and application logic is separable from each other by the middleware 304 so the same infrastructure can support a wide class of applications.

Single Application Instance—highly interactive applications have tight constraints on acceptable levels of latency as perceived by clients 104. To scale, applications may require geographically distributed servers 108. Regardless of distribution, the middleware 304 allows clients 104 to perceive the applications 306 as a single running instance; the distributed nature of the application 306 is transparent to the user.

Application Portability—along the same lines as above, the middleware 304 shields application developers from the distributed nature of the infrastructure that executes the application 306. Applications 306 run well on distributed and non-distributed platforms and are only minimally aware of the execution environment.

On-demand Resources Allocation—the middleware 304 distributes an application 306 across a larger number of servers 108 only when the increased workload becomes too large to handle. This differs from conventional implementations where computing resources for an application are decided a priori using some static decision process based on peak load. Thus, the infrastructure is truly on-demand by relying on the actual needs of the application 306 rather than allocating resources using static assignments of peak load.

Decentralized Control—due to the potentially large number of servers 108 needed to support highly interactive applications, centralized control mechanisms are avoided. Rather, the scheme employed to manage the servers 108 is based on de-centralized protocols and mechanisms that are robust to changes in application workloads as well as wide-area network conditions. At the same time, distributed control must still ensure some guarantees on the QoS perceived by the application and its clients.

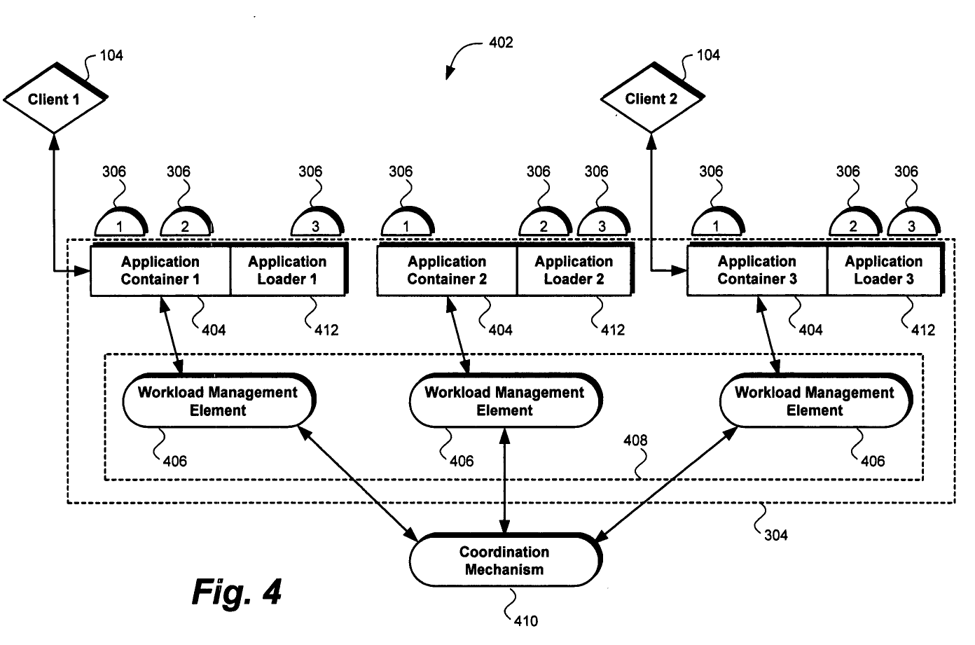

Referring now to FIG. 4, a diagram of exemplary functional architecture 402 for executing highly interactive applications according to an embodiment of the invention is shown. The tiered architecture includes the following four main components: clients 104, application code 306, application containers 404, and workload management elements 406. The workload management elements 406 collectively form a workload management layer 408, and the workload management layer 408 may employ a coordination mechanism 410 that facilitates distributed networking and consistency control for applications 306. In the figure, the application containers 404 and the workload management elements 406 constitute the middleware 304 upon which highly interactive applications 306 are executed.

The application code 306 performs work based on client requests. The different types of work an application 306 performs can be categorized using an application-specific metric. For example, an application 306 may add, delete, or update data in a database. In an MMOG, an application 306 may add, delete, or update information about a virtual world and then disseminate these changes to players. One categorization is to create three groups, corresponding to operation types: add, delete, and update. Another categorization is to use some arbitrary attributes of the client 104 that requests the work. For example, one can use the geographic location of the client, e.g. one can make two groups: “clients EAST of the Mississippi River” and “clients WEST of the Mississippi River.” In an MMOG, this is could be the location of the client 104 in the virtual word. When an application 306 is created, it specifies how its work should be grouped and passes this information to the application container 404. In one embodiment of the invention, one or more application containers 404 can run the same application 306 such that each application 306 is responsible for some subset of all the work groups for that application 306. It should be noted that these subsets may or may not overlap depending on the needs of the application 306.

An application container 404 is responsible for executing arbitrary application code 306 and ensuring that an application executing locally only does work it is responsible for. The application container 404 typically provides an interface that applications 306 conform to in order to execute in the application container 404. This interface also allows data exchange between the application container 404 and an arbitrary workload management element 406. In the figure, the application container 404 can instantiate and execute application code 306 using an application loader 412. The application loader 412 is responsible for passing application code 306 to the application container 404. It is contemplated that an administrator can place application code 306 in the application loader 412 manually or the code 412 can be downloaded from an external code source, such as a shared application repository. In FIG. 4, for example, executing applications 1 and 2 are shown above application container 1, while dormant application 3 (can be executed but currently not loaded into the container 404) is shown above the application loader 1.

Application containers 404 are associated to autonomous workload management elements 406. Unlike a traditional load balancer in tiered architectures, the workload management layer 408 provides load-balancing functions in a decentralized manner. The workload management layer 408 accomplishes this by creating an overlay network of workload management elements 406 that communicate with each other over a wide area network. Additionally, the workload management layer 408 provides consistency control mechanisms that allow the same application 306 executing on separate application containers 404 the ability to communicate state information with each other and to appear as a single application instance.

The workload management layer 408 controls the assignment of work to application containers 404 based on current workload conditions and the work groupings provided by the applications 306. The workload management layer 408 distributes load to application containers 404 in an on-demand fashion. Being on-demand refers to having only the minimal number of application containers 404 running application code 306 to maximize their utilization (work done per unit time) while other application containers 404 are free. Unlike traditional load-balancing schemes where all servers run application code but each server would likely have low utilization, the workload management layer 408 controls the underlying application infrastructure based on defined metrics. Specifically, the workload management layer 408 controls which applications 306 an application container 404 should execute, what group of work units an application container 404 should service for each application 306, and informs an application container 404 of the location of other application containers 404 that handle other work units for a given application 306.

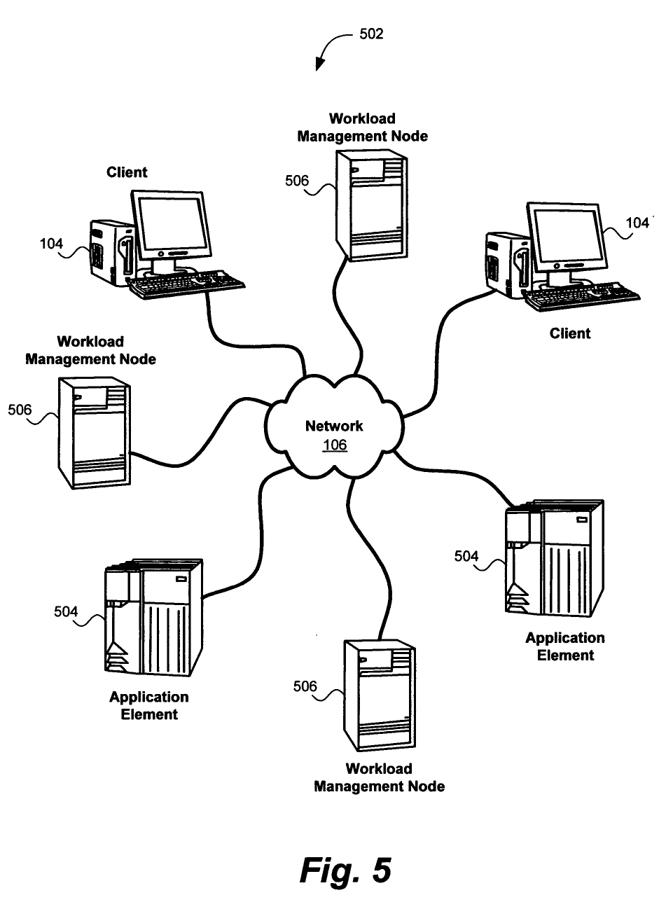

FIG. 5 shows an exemplary system 502 deploying highly interactive applications according to one embodiment of the present invention. In the figure, application code is executed in application containers running in application elements 504. Each application element 504 may include one or more application servers and one or more backend servers. Unlike traditional tiered architecture, the system 502 does not require a central load balancer. Instead, workload management nodes 506 are deployed on the wide-area network 106. Each application container communicates with one of the workload management nodes 506. The decision of which workload management node 506 the application container communicates with can be made manually by an administrator or based on a lookup mechanism such as Lightweight Directory Access Protocol (LDAP) that can inform application containers of the current, available workload management nodes. Thus, application containers are capable of running arbitrary application code that conforms to the application container interface. The workload management nodes 506 control how applications are spread over multiple application containers to prevent any application container from being overloaded. The workload management nodes 506 also act as a medium for communication between application containers to provide consistency control mechanisms for each application.

In one embodiment of the invention, clients tag or label their server requests with a key that classifies the request into a distinct work group during the execution of an application. The purpose of this key encoding is to provide a succinct way for the application container to determine if a client request can be serviced locally or if the request must be forwarded to another application container. In other words, client requests are labeled so that application containers can determine if the requests belong to the fractional workload assigned to the application instances. The creation of groups of work units is an application specific task and highly dependent on the nature of the application and the work it performs. Thus, it is contemplated that the key classification may be defined by each application and that each application may generate keys in many ways, including a hierarchical grouping and a non-hierarchical grouping.

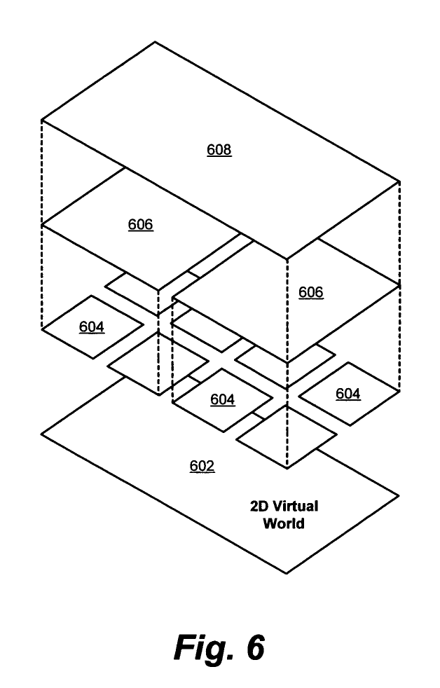

In a hierarchical grouping, a set first-level grouping of work units is itself placed in a set of second-level grouping, and so on until there is a single root group that contains all possible work units an application can perform. This type of grouping can be used by many applications. For example, in a MMOG, the application is primarily responsible for updating the state of a virtual world (usually a two-dimensional map). The virtual world can be divided into a large grid with an arbitrary number of grid cells. Such an arrangement is shown in FIG. 6, where a two-dimensional map 602 of a virtual world is divided into cells 604. The individual cells 604 can be grouped into larger cells 606, and these larger cells into yet larger cells 608. Each cell is considered a group assignable to an application container by the workload management layer. Therefore, intermediate cell group 606 represents four individual cells 604 of the two-dimensional map 602. Similarly, the top cell group 608 represents two intermediate cell groups 606, or eight individual cells 604, and contains the entire virtual world 602. Work units can be categorized by this grouping by assigning it to the cell that is affected by the work unit. The hierarchical grouping creates a “balanced tree” of groupings with the root of the tree being the largest grouping and the leaves of the tree being the highest resolution partitioning of the work unit space.

As an example, suppose a hierarchical grouping is created such that, at each level of grouping, two groups are combined into one. The effect of this is a binary tree of groups. If there is a total of three levels of grouping, a binary key can be created that has a length that ranges from one to three bits. At the third level of grouping (corresponding to the root of the hierarchy), a label of “0” is assigned. At the second level of grouping, the parent group is divided into two child groups, each receiving the label “00” and “01”, respectively. At the first level of grouping (leaves of the binary tree), we will have two child groups for group “00” and two child groups for group “01.” The children of group “00” can be labeled as “000”, “001” and the children of group “01” as “010”, “011.” This key encoding can now be used to identify groups at various levels (e.g. label “0” means all groups whereas label “011” specifically refers to a leaf node). Despite the example, the actual key encoding does not have to be binary but can be any encoding of tokens that can capture the relationship between parents and children through common prefixes. For more information about key identifiers, the reader is referred to U.S. patent application Ser. No. 10/718,401 titled “Adaptive Load Distribution in Managing Dynamic and Transient Data for Distributed Applications” filed Nov. 19, 2003.

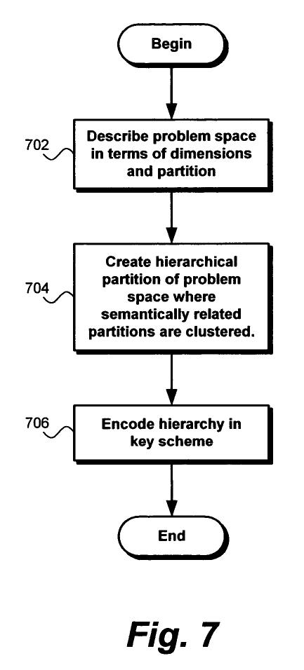

Turning now to FIG. 7, a flowchart for generating application keys is shown. Control flow begins at describing operation 702, where a hierarchical grouping of work units is defined. As mentioned above, the first-level groupings are placed in the second-level groupings and so on until there is a single root group that contains all possible work units an application can perform. Next, at creating operation 704, hierarchical partitions are created such that semantically related partitions are clustered. Finally, at encoding operation 706, the hierarchy is encoded using a key scheme. In one embodiment of the invention, keys are created for each grouping such that parent groups are related to their child groups because they share a common prefix.

As an example of a non-hierarchical grouping used in the present invention, imagine the same virtual world but this time overlaying a Cartesian coordinate system to define positions. In this arrangement, groupings can be identified by a set of vertices that define a closed polygon. To encode a key, the application takes the coordinates of the vertices and creates a label. For example, if the virtual word uses a rectangular two-dimensional coordinate system that ranges from coordinates (0,0) to (20,20), then we can define rectangular groups Group1 and Group2, with the Group1 having the coordinate range (0,0) to (10,10) and Group2 having the coordinate range (10,0) to (20,20). Client requests include as a key the vertices of the polygon that define a position in the virtual world, e.g. [(1,1), (1,2), (2,2), (2,1)], which would be defined as being part of Group1. In summary, workload tags may be coupled to inbound and outbound packet of application containers, and are configured to allow the application containers to identify whether the packets belong to its assigned workload.

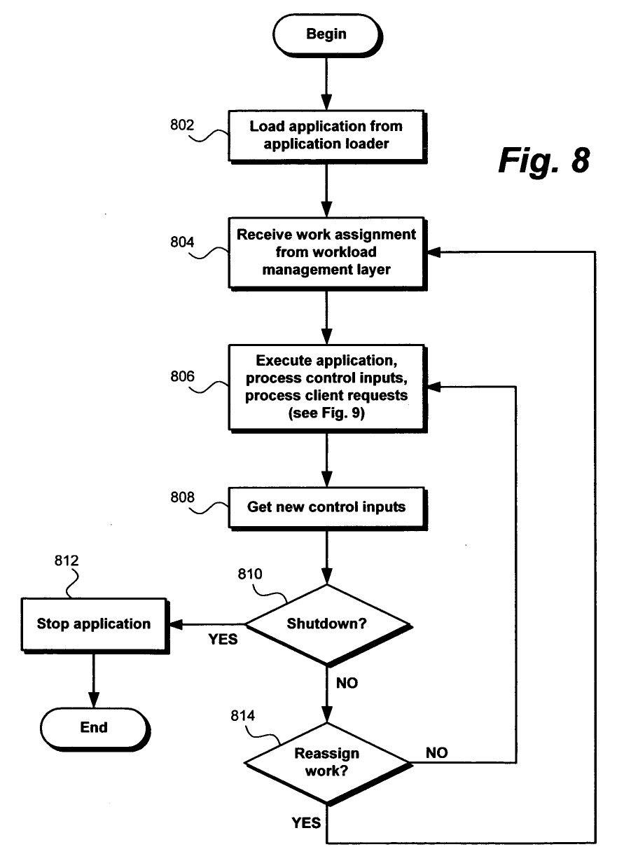

FIG. 8 shows an exemplary flowchart that an application container performs when loading and executing an application for the life of the application. It is noted that the flowcharts and corresponding descriptions provided herein are presented according to preferred sequences of operation. It is to be understood however that invention embodiments are not limited to the ordering of steps as shown. That is, the principles of the invention may be realized using alternate step sequences. It should also be remarked that the logical operations shown may be implemented (1) as a sequence of computer executed steps running on a computing system and/or (2) as interconnected machine modules within the computing system. The implementation is a matter of choice dependent on the performance requirements of the system implementing the invention. Accordingly, the logical operations making up the embodiments of the present invention described herein are referred to alternatively as operations, steps, or modules.

Process flow begins at loading operation 802, where the application container receives a request from either the workload management layer or an external administrator to launch an application. The application is available to the application container through the application loader. The application loader can store executable application code locally and forward the code to the application container, or alternatively, the application loader can retrieve executable application code from some other source and forward it to the application container. Once loading operation 802 has completed, control passes to receiving operation 804.

At receiving operation 804, the current workload assignment for the application is determined. The application container retrieves the key encoding scheme (for example, keys produced in the steps outlined in FIG. 7) from the application if necessary and consults the workload management layer. The workload management layer returns a work assignment to the application container for the newly loaded application. This work assignment specifies the work units the local application should process and other application containers that have an intersecting work assignment. For the former, the work assignment acts as a filtering mechanism for client requests. For the latter, the work assignment ensures that an application that is physically executing on multiple application containers has consistent state.

The work assignment specifies all keys that are members. If a key is a member, then it is a valid request that should be forwarded to the application. If not, the request should be forwarded to the workload management layer. The work assignment can be encoded in various ways, although the main intent is that it be done such that a key can be compared to the work assignment and a determination of whether or not the key is within the work assignment can be arrived at quickly. One such formulation is a hashing function that can be used to check for the membership of the key in a given set. Another formulation could be a table that lists all valid keys (or ranges of keys) along with a simple lookup mechanism to check for membership of the key within the work assignment. In the example of a MMOG, the work assignment could be based on a map of the virtual world that is partitioned into a grid of discrete cells that cover the map area. In a system with just two application containers, only keys that correspond to cells located on half the map are members of the work assignment. This can easily be specified using a Cartesian coordinate system and a range function.

After receiving operation 804 is completed and the application container receives its work assignment, control passes to executing operation 806. At executing operation 806, the application is executed as described in detail below. For immediate purposes, it should be recognized that during execution the application responds to client requests and processes control messages. When the application container receives a new control message, process flow passes to receiving operation 808.

There are two important control messages the application container must respond to: shutdown the application and change the work assignment for an application. These messages can be generated internally by the application container, or be received from the workload management layer. At determining operation 810, the application container tests whether the control message received is a shutdown control message. If the message is indeed a shutdown message, control passes to shutdown operation 812.

At shutdown operation 812, the application is stopped. During this operation, the executable application code can be moved to the application loader if necessary. For example, it may be the case that the application container will need to execute the same application sometime in the future. Once the application is shutdown, control flow ends.

Returning to determining operation 810, if the control message is not a shutdown message, flow passes determining operation 814. During this operation, the control message received is analyzed to determine if it is a change work assignment control message. If the message is not, control simply returns to executing operation 806. If the message is in fact a work assignment change, the application container updates the work assignment for the application by proceeding to receiving operation 804. The effect of this may increase or decrease the types of requests the application container will forward to the executing application.

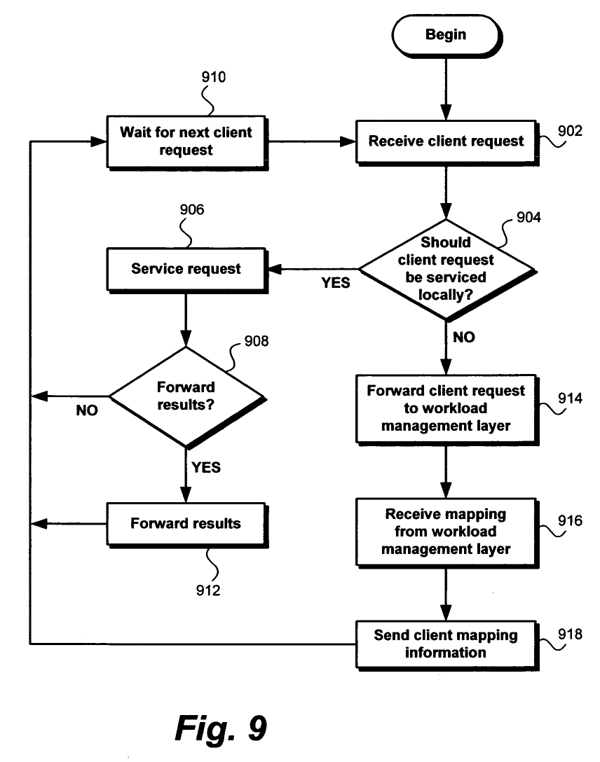

Referring now to FIG. 9, an exemplary flowchart is shown illustrating the operations the application container performs when receiving a client request. The process is initiated at receiving operation 902, where the application container receives a request from the client. In one embodiment of the invention, all client requests consist of three components: the identifier for the application the request should be directed to, the key that classifies the work the application will perform, and the request itself, which is formatted in some application-specific manner and opaque to the application container. After receiving operation 902 is completed, control passes to determining operation 904.

At determining operation 904, the application container determines whether or not the application container should forward the client request to a locally executed application. This determination is base on the key provided by the client request and the current work assignment of the application to which the request is directed. If the key is valid for the current work assignment, then process flow proceeds to servicing operation 906.

At servicing operation 906, the application container forwards the request to the application, which then services the request as appropriate. Once the request is forwarded, control flow passes to query operation 908, where the application container checks the work assignment to see if other application containers should be informed of any results such as state changes in the application. If the results do not need to be shared with other application containers, control passes to waiting operation 910.

If, at query operation 908, the results do need to be shared with other application containers, control passes to forwarding operation 912. In the example of an MMOG, this could correspond to two application containers running game code for the same game, where each one has a work assignment for different halves of the virtual world map. However, at the shared boundary of their work assignments, there is some overlap and both application containers can respond to client requests that affect these areas. To keep both executing applications consistent, it may be necessary for the local application to forward changes to the remotely executing application. This is reflected at forwarding operation 912, where shared state on the local application container is forwarded to a remote application container. Once the forwarding operation 912 is completed, control passes to waiting operation 910. At waiting operation 910, the application container waits for the next client request and, once received, starts the client request process all over again.

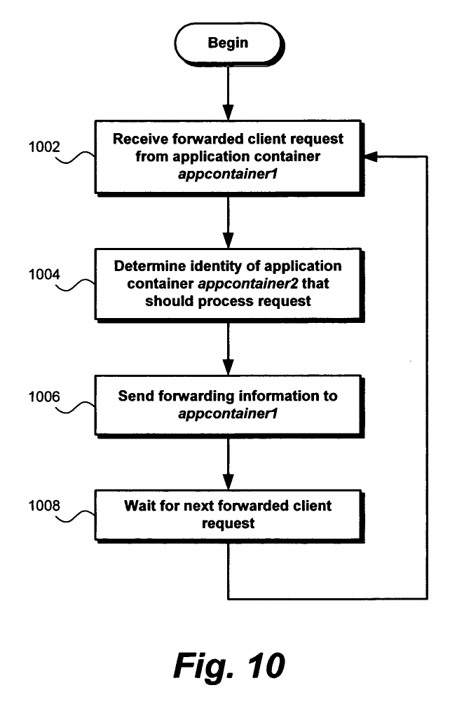

Returning to determining operation 904, if the key is not valid for the current work assignment, then process flow passes to forwarding operation 914. At forwarding operation 914, the current application container forwards the client request to the workload management layer. Once forwarded, the individual workload management element associated with the application container, using decentralized mechanisms, communicates with other workload management elements to determine the location of the application container that should receive the client request. Further details about this process are provided below with reference to FIG. 10.

Once workload management layer locates the appropriate application container that should receive the client request, the current application container receives the result at receiving operation 916. Next, at sending operation 918, the application container informs the client of the location of the application container that will handle the request. Once informed, the client “migrates” to the appropriate application container and reissues its request for processing. It is contemplated that if the workload management layer cannot locate an appropriate application container to service the client request, the current application container will receive an error condition at receiving operation 916 indicating the client request is invalid. This status is also forwarded to the client at sending operation 918.

Referring now to FIG. 10, an exemplary flow chart is shown illustrating the basic steps the workload management layer performs when a client request is received. As mentioned earlier, the workload management layer provides both workload management and consistency control mechanisms. For the former, the workload management layer controls application work assignments over distributed application containers. This additionally requires the latter, that the workload management layer facilitates communications between two application containers executing the same application.

The workload management layer may be distributed over many nodes (see FIG. 3). A coordination mechanism allows individual workload management elements the ability to locate each other and determine the current work assignments for each node. This coordination mechanism can utilize centrally controlled, shared information or rely on distributed, de-centralized mechanisms. Examples of each are provided as follows.

The process begins at receiving operation 1002, where a workload management element receives a forwarded client request from an application container. The process continues to determining operation 1004, where the workload management layer determines location of the application container that should handle the client request. It is contemplated that this determination can be accomplished in many ways. A centralized approach can rely on shared lookup tables that all workload management elements can query with the request key to determine which application container is responsible. The benefit of this architecture is simplicity as well as a computationally inexpensive lookup cost. The clear risk is that this centralized lookup table may become a bottleneck. To alleviate this concern, the workload management layer may alternatively resort to a distributed protocol for determining the location of the application container. There are many candidate distributed protocols known in the art that can be selected for this process. For example, the Distributed Hash Tables (DHT) architecture allows the robust, scalable storage and retrieval of values on thousands of participating nodes. For more information about Distributed Hash Tables, the reader is referred to Stoica et al., “Chord: A Scalable Peer-to-Peer Lookup Service for Internet Applications”, ACM SIGCOMM 2001. The Content and Load-Aware Scalable Hashing (CLASH) method extends the DHT architecture to support dynamic workloads experienced by a highly interactive application like an MMOG. For more information about Content and Load-Aware Scalable Hashing, the reader is referred to Misra, A., Castro, P., Lee, J., “CLASH: A Protocol for Internet-Scale Utility-Oriented Distributed Computing”, The 24th International Conference on Distributed Computing System (ICDCS), 2004. Each workload management element maps to a “server” in the DHT/CLASH method, and employs lookup mechanisms to determine the location of the application container that can handle the request. This is more complex than the lookup table solution, but has much better scalability properties with a higher lookup cost.

Once the lookup is complete, the procedure continues to sending operation 1006. At sending operation 1006, the workload management layer forwards the lookup result back to the original application container. The application container, in turn, forwards the result to the client. The process then proceeds to waiting operation 1008, where the workload management layer waits for the next forwarded client request to repeat the lookup process.

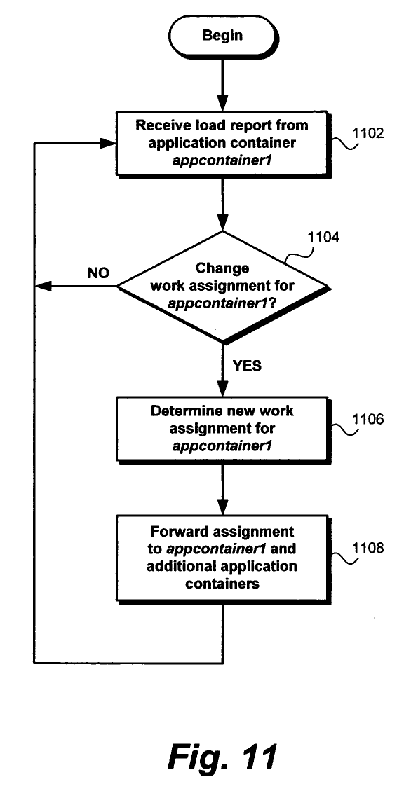

Turning to FIG. 11, an exemplary flowchart illustrating the steps taken by the workload management layer when it receives a load report from an application container is shown. A load report contains metrics concerning the current QoS the application container can provide for each of its applications. It is contemplated that the QoS metrics may be standardized metrics, such as request service latency and request queue length, found in performance literature and other sources. The workload management layer collects load reports and periodically updates work assignments for applications executing in application containers. The methodology starts at receiving operation 1102, where the workload management layer receives a report from an application container that contains metrics for one or more currently executing applications. Next, at query operation 1104, workload management layer determines if the work assignment for the application container needs to be changed. This is primarily based on the level of QoS that the application container can provide to its currently executing applications. If no change is required to the work assignment of the application container, process flow return to receiving operation 1102 and the workload management layer waits for another load report. If, however, the work assignment must be changed, control transfers to determining operation 1106.

At determining operation 1106, the workload management layer determines the new work assignment. The determination of the appropriate assignment is generally an application dependent process. In the example of the MMOG, this could be assigning some portion of the virtual world map to an application. Updating work assignments in this instance means changing what portions of the map the application is responsible for. In the case of DHT/CLASH, this work assignment is determined by the hierarchical encoding of the work units. Decreasing the amount of work (in the case that the application container cannot meet QoS requirements) means further splitting a work assignment into “finer” resolution groups and “handing-off” work to other application containers. Increasing the amount of work (in the case that the application container can easily meet its QoS requirements) means combining finer resolution groups into a single lower resolution group and placing this group on a single application container. The effect of such a merger is to cease execution of the application on other application containers and have a single application container process the combined work previously distributed. After determining operation 1106 is completed, the procedure continues to forwarding operation 1108.

At forwarding operation 1108, the new work assignment is forwarded to the application container that sent the load report. If the work assignment requires the handing-off of work to other application containers, the workload management layer forwards the assignment to the appropriate application containers. If the work assignment requires the aggregation of work onto a single application container, then the workload management layer forwards this message to the appropriate application containers. Once forwarding operation 1108 is completed, process flow return to receiving operation 1102 and the workload management layer waits for another load report.

Changing the work assignment may require the launching of an application that is not currently executing on an application container. For example, in an MMOG, the initial state of an executing application could be on a single application container with the entire virtual world map as the initial work assignment. If the QoS for the application falls below prescribed levels, the workload management layer will contact a new application container and assign it work (e.g. half of the virtual world map). The application container will have to launch the application as described above (see FIG. 8), though it may not need to request the work assignment again from the workload management layer if it was already provided as part of a work assignment update.

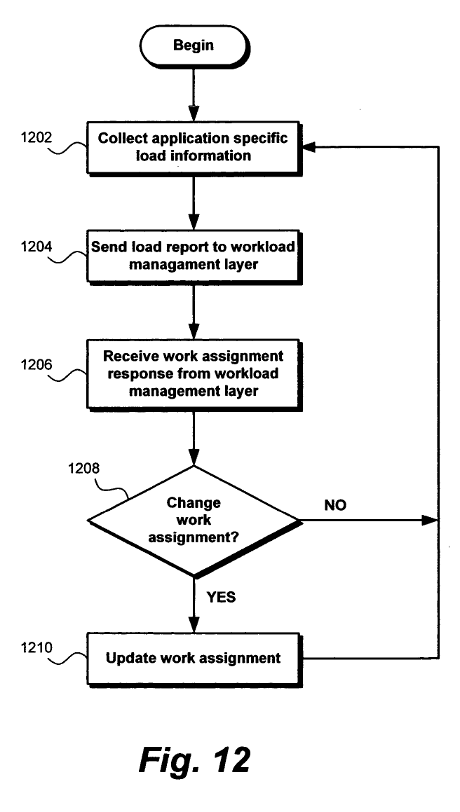

FIG. 12 is an exemplary flowchart illustrating how an application container reports its load to the workload management layer. Control flow starts at collecting operation 1202, where the application container collects metrics regarding QoS for each of its applications. An example QoS metric could be the time it takes to process a client request. It may also be the number of outstanding client requests that are buffered and awaiting processing, or the number of lower-level disk memory requests. It should be noted that the metric used is not limited to the examples discussed. Once the metrics are collected, control passes to sending operation 1204.

At sending operation 1204, the application container assembles a load report and sends it to the workload management layer. Next, the process continues to receiving operation 1206, where the application container receives the work assignment response from the workload management layer. The response should at least state whether the application container should, for a given application, not change in work assignment, decrease current work assignment (which may stop an application if the work assignment is completely removed), or increase current work assignment. If the workload management layer response indicates that the application work assignment should stay the same, control returns to collecting operation 1202. Otherwise, the procedure branches to updating operation 1210.

At updating operation 1210, the application container changes its work assignment for one or more applications currently executing. The process then returns to collecting operation 1202 where metrics for a new load report are collected. Note that the application container does not need to migrate clients (who are currently sending it requests) to other application containers, since this will happen as discussed above with reference to FIG. 9.

The foregoing description of the invention has been presented for purposes of illustration and description. It is not intended to be exhaustive or to limit the invention to the precise form disclosed, and other modifications and variations may be possible in light of the above teachings. The embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for executing a network-based distributed application, the method comprising:
executing application instances of the distributed application in application containers;
calculating quality of service metrics for each application instance; and
distributing application workload among the application instances using a decentralized workload management layer based on the quality of service metrics.

2. The method of claim 1, further comprising associating application containers with autonomous workload management elements, the workload management elements forming the workload management layer.

3. The method of claim 2, further comprising coordinating the application instances through a coordination mechanism coupled to the workload management layer.

4. The method of claim 1, wherein distributing application workload among the application instances further comprises reducing workload assigned to an application container when the quality of service metrics reach an overload threshold value.

5. The method of claim 4, wherein reducing workload assigned to the application container further comprises:
examining an encoding of work unit groups provided by each application instance;
splitting a currently assigned work unit group into smaller work unit groups;
assigning at least one of the smaller work unit groups to other application containers; and
utilizing a coordination mechanism to update changes in workload assignments to the other application containers

6. The method of claim 1, wherein distributing application workload among the application instances further comprises increasing workload assigned to the application container when the quality of service metrics reach an under-load threshold value.

7. The method of claim 6, wherein increasing workload assigned to the application container further comprises:
examining an encoding of work unit groups provided by each application instance;
combining at least two currently assigned work unit groups into a smaller work unit group;
assigning the smaller work unit group to the application container; and
utilizing a coordination mechanism to update changes in workload assignments to the other application containers.

8. The method of claim 1, further comprising dividing workload assigned to a single application instance to at least two application instances if a quality of service metric reaches an overload threshold.

9. The method of claim 1, further comprising:
dividing a total workload performed by the distributed application among the application instances;
assigning each of the application instances a fractional workload; and
filtering client requests at the application containers based on the fractional workload assigned to the application instances.

10. The method of claim 9, further comprising migrating a client from a first application container to a second application container if workload from the client is not assigned to the application instance executing at the first application container.

11. The method of claim 10, further comprising labeling client requests such that application containers can determine if the requests belong to the fractional workload assigned to the application instances.

12. The method of claim 1, further comprising receiving the application instances from application loaders.

13. A system for executing a distributed computer application, the system comprising:
one or more application containers configured to execute an application instance of the distributed application and determine quality of service metrics for the application instance; and
one or more workload management elements forming a decentralized workload management layer, each workload management element is configured to be associated to one of the application containers and to assign a workload to the application container based on the quality of service metrics received by the application container.

14. The system of claim 13, wherein each workload management element is further configured to autonomously increase and decrease the assigned workload to its associated application container.

15. The system of claim 14, wherein each workload management element is further configured to divide the assigned workload to two or more application containers if the assigned workload to its associated application container is to be decreased.

16. The system of claim 14, wherein each workload management element is further configured to combine the assigned workload of two or more application containers if the assigned workload to its associated application container is to be increased.

17. The system of claim 13, wherein each application container is further configured to pass inbound packets to executing application instances when the inbound packets belong to the its assigned workload, and to pass inbound packets to its associated workload management element when the inbound packets do not belong to its assigned workload.

18. The system of claim 13, further comprising workload tags coupled to data packets of application containers, the workload tags configured to allow application containers to identify whether the inbound packets belong to its assigned workload.

19. The system of claim 13, further comprising a coordination mechanism configured to workload management elements to locate each other and determine the current work assignments of each application container.

20. The system of claim 13, further comprising an application loader configured to provide executable application code to application containers.

21. A computer program product embodied in a tangible media comprising:
computer readable program codes coupled to the tangible media for executing a network-based distributed application, the computer readable program codes configured to cause the program to:
execute application instances of the distributed application in application containers;
receive quality of service metrics for each application instance; and
distribute application workload among the application instances using a decentralized workload management layer based on the quality of service metrics.

22. The computer program product of claim 21, further comprising program code configured to associate application containers with workload management elements, the workload management elements forming the workload management layer.

23. The computer program product of claim 22, further comprising program code configured to coordinate the application instances through a coordination mechanism coupled to the workload management layer.

24. The computer program product of claim 21, wherein the program code configured to cause the program to distribute application workload among the application instances further comprises program code to the program to reduce workload assigned to an application container when the quality of service metrics reach an overload threshold value.

25. The computer program product of claim 23, wherein the program code configured to cause the program to reduce workload assigned to the application container further comprises program code to the program to:
examine an encoding of work unit groups provided by each application instance;
split a currently assigned work unit group into smaller work unit groups;
assign at least one of the smaller work unit groups to other application containers; and
utilize a coordination mechanism to update changes in workload assignments to the other application containers.

26. The computer program product of claim 21, wherein the program code configured to cause the program to distribute application workload among the application instances further comprises program code to the program to increase workload assigned to the application container when the quality of service metrics reach an under-load threshold value.

27. The computer program product of claim 26, wherein the program code configured to cause the program to increase workload assigned to the application container further comprises program code to the program to:
examine an encoding of work unit groups provided by each application instance;
combine at least two currently assigned work unit groups into a smaller work unit group;
assign the smaller work unit group to the application container; and
utilize a coordination mechanism to update changes in workload assignments to the other application containers.

28. The computer program product of claim 21, further comprising program code configured to divide workload assigned to a single application instance to at least two application instances if a quality of service metric reaches an overload threshold.

29. The computer program product of claim 21, further comprising program code configured to:
divide a total workload performed by the distributed application among the application instances;
assign each of the application instances a fractional workload; and
filter client requests at the application containers based on the fractional workload assigned to the application instances.

30. The computer program product of claim 29, further comprising program code configured to migrate a client from a first application container to a second application container if workload from the client is not assigned to the application instance executing at the first application container.

31. The computer program product of claim 30, further comprising program code configured to label client requests such that application containers can determine if the requests belong to the fractional workload assigned to the application instances.

32. The computer program product of claim 21, further comprising program code configured to receive the application instances from application loaders.
